(19) United States
(12) Patent Application Publication
(10) Pub. No.: US 2011/0176150 A1
(43) Pub. Date: Jul. 21, 2011

(54) METHOD AND APPARATUS FOR CONVERTING LARGER-SIZED DOCUMENTS TO SMALLER-SIZED DOCUMENTS IN AN IMAGE PRODUCTION DEVICE

(75) Inventors: Danielle Renee HALL, Wilsonville, OR (US); Martin Scott Walsh, Portland, OR (US)

(73) Assignee: XEROX CORPORATION, Norwalk, CT (US)

(21) Appl. No.: 12/690,282

(22) Filed: Jan. 20, 2010

(51) Int. Cl. G06K 15/02

(52) U.S. Cl. 358/1.2; 358/474; 358/1.13; 358/451; 358/450

(57) ABSTRACT

A method and apparatus for converting larger-sized documents to smaller-sized documents in an image production device is disclosed and may include receiving a request to scan a larger-sized document, determining if the larger-sized document is to be converted to a smaller-sized-document, wherein if it is determined that the larger-sized document is to be converted to a smaller-sized-document, scanning the larger-sized document to obtain image data, combining the image data from each larger-sized document page into one continuous document, measuring a predetermined amount of image data from the one continuous document, positioning the predetermined amount of image data onto a smaller-sized document page, continue positioning the predetermined amount of image data onto a smaller-sized document pages until there is no more image data left from the one continuous document to position onto a smaller-sized document page, and one of storing the smaller-sized document in a memory and printing the smaller-sized document.

### BACKGROUND

Disclosed herein is a method for converting larger-sized documents to smaller-sized documents in an image production device, as well as corresponding apparatus and computer-readable medium.

Larger-sized documents (e.g., legal-sized, B (or ledger), A3, Super A3, Super B, or other larger-sized documents) are becoming increasing unpopular in today's world. For example, legal-sized documents are rarely used as they are difficult to handle, store, copy, and are more expensive to reproduce and store than smaller-sized documents, such as the more popular letter-sized and A4-sized documents.

As more and more entities such as businesses, government, etc. begin to expressly use and store electronic documents instead of paper, in order to archive or make the legal-sized documents useful, those entities must scan the legal-sized electronic documents and convert them to the user-friendly smaller-sized documents. This process may involve:
1) Scanning the document and reducing the size of the document to fit on the desired output page size—compromising readability and image quality.
2) Manually cutting the page to the desired output page size and then re-copying or scanning.
3) Scanning the document, bringing the scanned images into an image processing software program, and manually cropping the images to fit on standard size pages.
4) Copying the legal size documents to two letter size pages—the first with 11″ of length to the page and the second with only 3″ of information and the rest white-space.

This process is expensive, tedious, and time-consuming for entities archiving or copying legal-sized documents in a more user-friendly paper size (e.g., letter or A4).

### SUMMARY

A method and apparatus for converting larger-sized documents to smaller-sized documents in an image production device is disclosed. The method may include receiving a request to scan a larger-sized document, determining if the larger-sized document is to be converted to a smaller-sized-document, wherein if it is determined that the larger-sized document is to be converted to a smaller-sized-document, scanning the larger-sized document to obtain image data from each larger-sized document page, combining the image data from each larger-sized document page into one continuous document, measuring a predetermined amount of image data from the one continuous document, positioning the predetermined amount of image data onto a smaller-sized document page, continue positioning the predetermined amount of image data onto a smaller-sized document pages until there is no more image data left from the one continuous document to position onto a smaller-sized document page, and one of storing the smaller-sized document in a memory and printing the smaller-sized document.

### BRIEF DESCRIPTION OF THE DRAWINGS

FIG. 1 is an exemplary diagram of an image production device in accordance with one possible embodiment of the disclosure;

FIG. 2 is an exemplary block diagram of the image production device in accordance with one possible embodiment of the disclosure;

FIG. 3 is a flowchart of an exemplary larger-sized document conversion process in accordance with one possible embodiment of the disclosure; and

FIG. 4 is an exemplary diagram illustrating the larger-sized document conversion process in accordance with one possible embodiment of the disclosure.

### DETAILED DESCRIPTION

Aspects of the embodiments disclosed herein relate to a method for converting larger-sized documents to smaller-sized documents in an image production device, as well as corresponding apparatus and computer-readable medium.

The disclosed embodiments may include a method for converting larger-sized documents to smaller-sized documents in an image production device. The method may include receiving a request to scan a larger-sized document, determining if the larger-sized document is to be converted to a smaller-sized-document, wherein if it is determined that the larger-sized document is to be converted to a smaller-sized-document, scanning the larger-sized document to obtain image data from each larger-sized document page, combining the image data from each larger-sized document page into one continuous document, measuring a predetermined amount of image data from the one continuous document, positioning the predetermined amount of image data onto a smaller-sized document page, continue positioning the predetermined amount of image data onto a smaller-sized document pages until there is no more image data left from the one continuous document to position onto a smaller-sized document page, and one of storing the smaller-sized document in a memory and printing the smaller-sized document.

The disclosed embodiments may further include an image production device that may include a memory, a scanner that scans and records image data from documents, and a larger-sized document conversion unit that receives a request to scan a larger-sized document, determines if the larger-sized document is to be converted to a smaller-sized-document, wherein if the larger-sized document conversion unit determines that the larger-sized document is to be converted to a smaller-sized-document, the larger-sized document conversion unit scans the larger-sized document using the scanner to obtain image data from each larger-sized document page, combines the image data from each larger-sized document page into one continuous document, measures a predetermined amount of image data from the one continuous document, positions the predetermined amount of image data onto a smaller-sized document page, continues positioning the predetermined amount of image data onto a smaller-sized document pages until there is no more image data left from the one continuous document to position onto a smaller-sized document page, and one of storing the smaller-sized document in the memory and printing the smaller-sized document.

The disclosed embodiments may further include a computer-readable medium storing instructions for controlling a computing device for converting larger-sized documents to smaller-sized documents in an image production device. The instructions may include receiving a request to scan a larger-sized document, determining if the larger-sized document is to be converted to a smaller-sized-document, wherein if it is determined that the larger-sized document is to be converted to a smaller-sized-document, scanning the larger-sized document to obtain image data from each larger-sized document page, combining the image data from each larger-sized document page into one continuous document, measuring a predetermined amount of image data from the one continuous document, positioning the predetermined amount of image data onto a smaller-sized document page, continue positioning the predetermined amount of image data onto a smaller-sized document pages until there is no more image data left from the one continuous document to position onto a smaller-sized document page, and one of storing the smaller-sized document in a memory and printing the smaller-sized document.

The disclosed embodiments may concern converting larger-sized documents (such as legal-sized, B (or ledger), A3, Super A3, Super B, or other larger-sized documents) to smaller-sized documents in an image production device. A scanner on the image production device may capture 14″ images (for legal-sized documents) and essentially form them into a continuous document without page length breaks or margins. The next task may be to find convenient white spaces (likely line breaks) at approximately every 9″-11″ (for converting a legal-sized document to a letter-sized document, for example) and make the page splits. This process may be stepped and repeated to create full 11″ pages rather than the large white spaces left if this process is done manually with a platen scanner. In this process, the size of the image data is not zoomed, reduced, etc. and may appear substantially the same size as it appeared in the larger-sized document.

For example, this process may be valuable for companies archiving legal-sized documents or wishing to copy legal-sized documents so that the cost of legal-sized document printing capability, filing size, or inconvenient paper size may be avoided. The process may allow for easy conversion of legal-sized documents into letter-sized or A4-sized archives—both scanned and hard copy, for example.

This process may also provide a great environmental message in that there may be less waste generated when multiple page legal-sized documents (or other larger-sized documents) can be automatically “split” and “stitched” together to minimize whitespace—enabling the customer to seamlessly convert legal-sized documents to more common business sizes (e.g., letter/A4). This process may also allow for a lower-cost image production section in the copier, one that only prints on letter/A4 media, but can accept legal images through the automatic document feeder or on the platen so that they may be scanned and copied without compromising image quality.

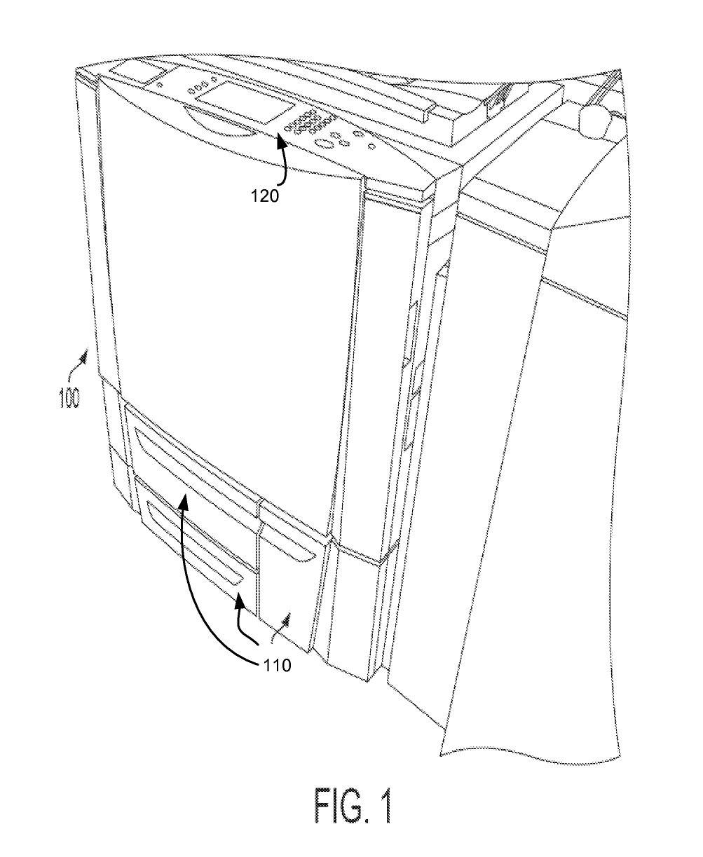

FIG. 1 is an exemplary diagram of an image production device 100 in accordance with one possible embodiment of the disclosure. The image production device 100 may be any device that may be capable of making image production documents (e.g., printed documents, copies, etc.) including a copier, a printer, a facsimile device, and a multi-function device (MFD), for example.

The image production device 100 may include one or more media tray doors 110 and a local user interface 120. The one or more media tray doors 110 may provide access to one or more media trays that contain media. The one or more media tray doors 110 may be opened by a user so that media may be checked, replaced, or to investigate a media misfeed or jam, for example.

The user interface 120 may contain one or more display screen (which may be a touchscreen or simply a display, for example), and a number of buttons, knobs, switches, etc. to be used by a user to control image production device 100 operations. The one or more display screen may also display warnings, alerts, instructions, and information to a user. While the user interface 120 may accept user inputs, another source of image data and instructions may include inputs from any number of computers to which the printer is connected via a network, for example.

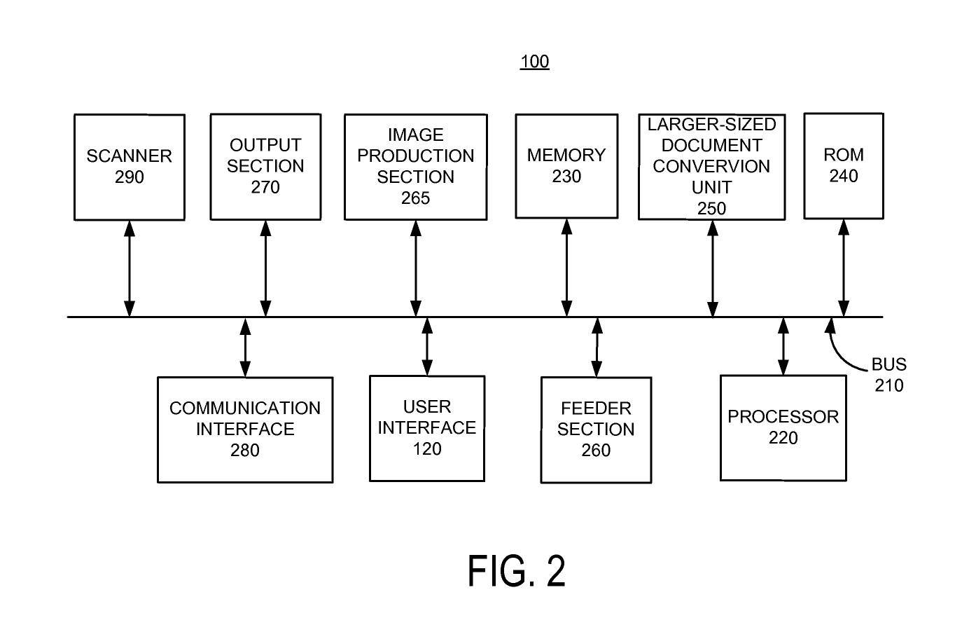

FIG. 2 is an exemplary block diagram of the image production device 100 in accordance with one possible embodiment of the disclosure. The image production device 100 may include a bus 210, a processor 220, a memory 230, a read only memory (ROM) 240, the larger-sized document conversion unit 250, the user interface 120, a feeder section 260, an image production section 265, an output section 270, a communication interface 280, and a scanner 290. Bus 210 may permit communication among the components of the image production device 100.

The image production section 265 may include hardware by which image signals are used to create a desired image. The stand-alone feeder section 260 may store and dispense media sheets on which images are to be printed. The output section 270 may include hardware for stacking, folding, stapling, binding, etc., prints which are output from the image production section. If the image production device 100 is also operable as a copier, the image production device 100 may further includes a document feeder and scanner which may operate to convert signals from light reflected from original hard-copy image into digital signals, which are in turn processed to create copies with the image production section 265.

With reference to feeder section 260, the section may include one or more media trays, each of which stores a media stack or print sheets (“media”) of a predetermined type (size, weight, color, coating, transparency, etc.) and may include a feeder to dispense one of the media sheets therein as instructed. The media trays may be accessed by a user by opening the one or more media tray doors 110. One or more media tray door sensors may sense if one or more media tray door is either open or closed. The one or more media tray door sensors may be any sensors known to one of skill in the art, such as contact, infra-red, magnetic, or light-emitting diode (LED) sensors, for example. The one or more media tray size sensors may be any sensors that may detect media size in a media known to one of skill in the art, including switches, etc.

Certain types of media may require special handling in order to be dispensed properly. For example, heavier or larger media may desirably be drawn from a media stack by use of an air knife, fluffer, vacuum grip or other application (not shown in the Figure) of air pressure toward the top sheet or sheets in a media stack. Certain types of coated media may be advantageously drawn from a media stack by the use of an application of heat, such as by a stream of hot air (not shown in the Figure). Sheets of media drawn from a media stack on a selected media tray may then be moved to the image production section 265 to receive one or more images thereon. Then, the printed sheet is then moved to output section 270, where it may be collated, stapled, folded, punched, etc., with other media sheets in manners familiar in the art.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

User interface 120 may include one or more conventional mechanisms that permit a user to input information to and interact with the image production device 100, such as a keyboard, a display, a mouse, a pen, a voice recognition device, touchpad, buttons, etc., for example. Output section 270 may include one or more conventional mechanisms that output image production documents to the user, including output trays, output paths, finishing section, etc., for example. The image production section 265 may include an image printing and/or copying section, a scanner, a fuser, etc., for example. Scanner 290 may an automatic document feeder scanner, platen scanner, or any other scanner known to one of skill in the art that may be able to record and process image data.

The image production device 100 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 100 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 100, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like that are capable of displaying the print release marking and can be scanned by the image production device 100.

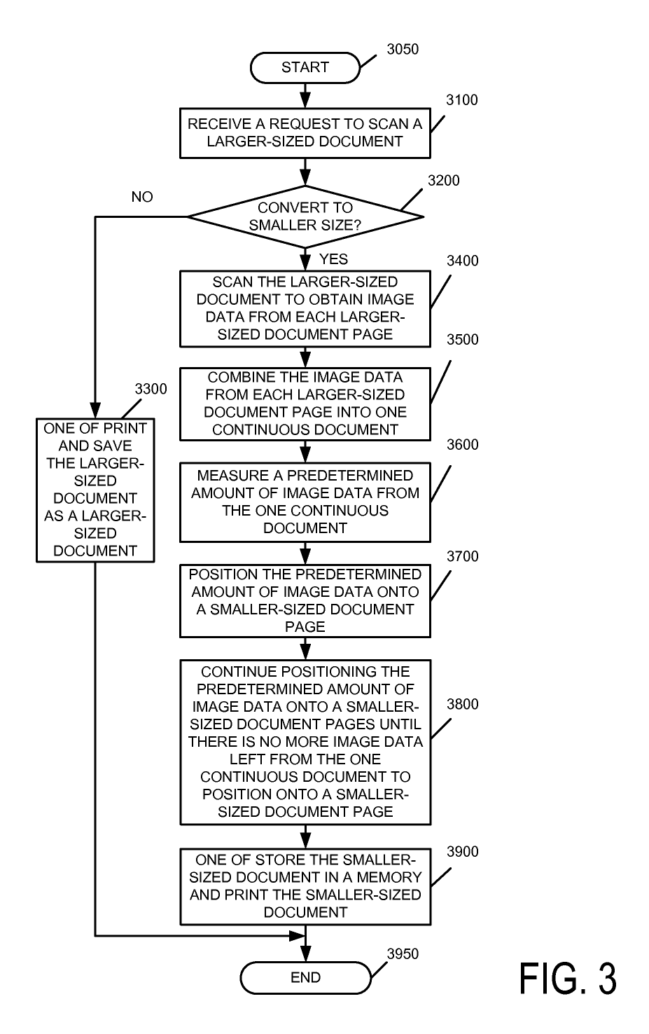

The operation of components of the larger-sized document conversion unit 250 and the larger-sized document conversion process will be discussed in relation to the flowchart in FIG. 3.

FIG. 3 is a flowchart of a larger-sized document conversion process in accordance with one possible embodiment of the disclosure. The method may begin at step 3050, and may continue to step 3100 where the larger-sized document conversion unit 250 may receive a request to scan a larger-sized document. The larger-sized document may be legal-sized, B (or ledger), A3, Super A3, Super B, or other larger-sized documents, for example. At step 3200, the larger-sized document conversion unit 250 may determine if the larger-sized document is to be converted to a smaller-sized-document. The smaller-sized document may be one of a letter-sized document, an A4-sized document, etc., for example. If the larger-sized document conversion unit 250 determines that the larger-sized document is not to be converted to a smaller-sized-document, at step 3300 the larger-sized document conversion unit 250 may either store the smaller-sized document in the memory 230 or print the smaller-sized document. The process may then go to step 3950 and end.

If at step 3200, the larger-sized document conversion unit 250 determines that the larger-sized document is to be converted to a smaller-sized-document, at step 3400 the larger-sized document conversion unit 250 may scan the larger-sized document using the scanner 290 to obtain image data from each larger-sized document page. At step 3500, the larger-sized document conversion unit 250 may combine the image data from each larger-sized document page into one continuous document. The image data may be text, pictures, graphs, tables, etc. or a combination thereof.

At step 3600, the larger-sized document conversion unit 250 may measure a predetermined amount of image data from the one continuous document. This predetermined amount of image data may be 9″-10.5″ for a letter-sized or A-4-sized document, for example. The larger-sized document conversion unit 250 may also determine the predetermined amount of image data so that a minimum amount of white space is provided at the edges of the smaller-sized document pages. The minimum amount of white space may be 0.25-1.5 inches at the edges of the smaller-sized document pages, for example. The larger-sized document conversion unit 250 may determine the end of image data on a larger-sized document page by recognizing a predetermined amount of white space on the larger-sized document page, for example.

At step 3700, the larger-sized document conversion unit 250 may position the predetermined amount of image data onto a smaller-sized document page. At step 3800, the larger-sized document conversion unit 250 may continue to position the predetermined amount of image data onto a smaller-sized document pages until there is no more image data left from the one continuous document to position onto a smaller-sized document page. The final smaller-sized document page may have only part of the page filled with image data. At step 3900, the larger-sized document conversion unit 250 may either store the smaller-sized document in the memory 330 or print the smaller-sized document. The smaller-sized document may be converted to PDF or be stored in a word processing format (e.g., Word®) prior to being stored in the memory 330, for example. Note that this process, the size of the image data from the larger-sized document is not changed when it is converted to the smaller-sized document. Therefore, the size of the image data is not zoomed, reduced, etc. and may appear substantially the same size as it appeared in the larger-sized document. The process may then go to step 3950 and end.

The process may involve an image production device such as a desktop copier, inkjet or otherwise, that is usually “short edge feed to short edge feed” or SEF to SEF. In other words, whether the original is legal or letter, you stick the short (8.5 inch) edge into the feeder; and the output comes out SEF as well. This is the process generally described above. In such a situation, a legal sheet is simply longer, along the process direction, than a letter, and the image data can be combined as described above.

However, larger hallway image production devices are “long edge feed” or LEF when they output letter-sized copies so that the copies are output 11 inches across. When copying from larger-sized documents to smaller-sized documents (such as legal-sized to letter-sized), because the input scanners are not 14 inches wide, the short 8.5 inch edge of a legal sheet is placed into the (usually 11 inch wide) input scanner. When it is desired to convert a legal-sized document to a letter-sized document, in a larger image production devices, the document will be processed from SEF legal to LEF letter, and image data may have to be rotated 90 degrees by the larger-sized document conversion unit 250 prior to being “stitched” or combined into the one continuous document. However, this image data rotation may take place during any part of the process, including anytime prior to positioning the image data onto the smaller-sized document pages.

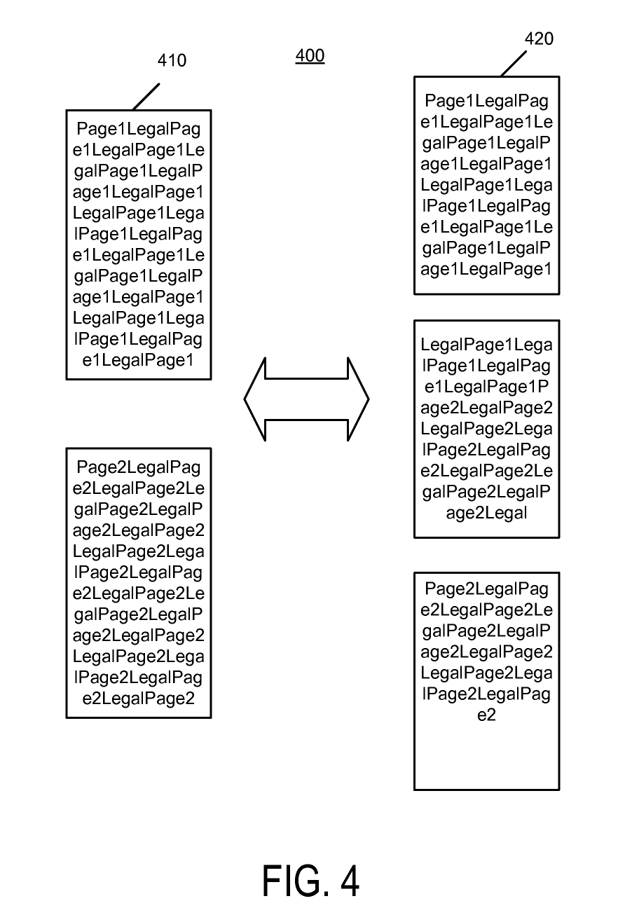

FIG. 4 is an exemplary diagram 400 illustrating the larger-sized document conversion process in accordance with one possible embodiment of the disclosure. The sequence of images may show how an exemplary two-page legal-sized document 410 may be scanned and combined or (or “stitched”) together and output on three letter-sized media sheets 420.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for converting larger-sized documents to smaller-sized documents in an image production device, comprising:
receiving a request to scan a larger-sized document;
determining if the larger-sized document is to be converted to a smaller-sized-document, wherein if it is determined that the larger-sized document is to be converted to a smaller-sized-document,
scanning the larger-sized document to obtain image data from each larger-sized document page;
combining the image data from each larger-sized document page into one continuous document;
measuring a predetermined amount of image data from the one continuous document;
positioning the predetermined amount of image data onto a smaller-sized document page;
continue positioning the predetermined amount of image data onto a smaller-sized document pages until there is no more image data left from the one continuous document to position onto a smaller-sized document page; and
one of storing the smaller-sized document in a memory and printing the smaller-sized document.

2. The method of claim 1, wherein the smaller-sized document is one of a letter-sized document and an A4-sized document.

3. The method of claim 1, wherein the predetermined amount of image data is determined so that a minimum amount of white space is provided at the edges of the smaller-sized document pages.

4. The method of claim 3, wherein the minimum amount of white space is 0.25-1.5 inches at the edges of the smaller-sized document pages.

5. The method of claim 1, wherein the predetermined amount of image data may be 9″-10.5″.

6. The method of claim 1, wherein the larger-sized document is one of legal-sized, B (ledger), A3, Super A3, and Super B.

7. The method of claim 1, wherein the image production device is one of a copier, a printer, a facsimile device, and a multi-function device.

8. The method of claim 1, wherein the size of the image data from the larger-sized document is not changed when it is converted to the smaller-sized document.

9. The method of claim 1, wherein the image data is rotated 90 degrees prior to the predetermined amount of image data being positioned onto a smaller-sized document page.

10. An image production device, comprising:
a memory;
a scanner that scans and records image data from documents; and
a larger-sized document conversion unit that receives a request to scan a larger-sized document, determines if the larger-sized document is to be converted to a smaller-sized-document, wherein if the larger-sized document conversion unit determines that the larger-sized document is to be converted to a smaller-sized-document, the larger-sized document conversion unit scans the larger-sized document using the scanner to obtain image data from each larger-sized document page, combines the image data from each larger-sized document page into one continuous document, measures a predetermined amount of image data from the one continuous document, positions the predetermined amount of image data onto a smaller-sized document page, continues positioning the predetermined amount of image data onto a smaller-sized document pages until there is no more image data left from the one continuous document to position onto a smaller-sized document page, and one of storing the smaller-sized document in the memory and printing the smaller-sized document.

11. The image production device of claim 10, wherein the smaller-sized document is one of a letter-sized document and an A4-sized document.

12. The image production device of claim 10, wherein the larger-sized document conversion unit determines the predetermined amount of image data so that a minimum amount of white space is provided at the edges of the smaller-sized document pages.

13. The image production device of claim 12, wherein the minimum amount of white space is 0.25-1.5 inches at the edges of the smaller-sized document pages.

14. The image production device of claim 10, wherein the predetermined amount of image data may be 9″-10.5″.

15. The image production device of claim 10, wherein the larger-sized document is one of legal-sized, B (ledger), A3, Super A3, and Super B.

16. The image production device of claim 10, wherein the image production device is one of a copier, a printer, a facsimile device, and a multi-function device.

17. The image production device of claim 10, wherein the size of the image data from the larger-sized document is not changed when it is converted to the smaller-sized document.

18. The image production device of claim 10, wherein the larger-sized document conversion unit 250 rotates the image data 90 degrees prior to positioning the predetermined amount of image data onto a smaller-sized document page.

19. A computer-readable medium storing instructions for controlling a computing device for converting larger-sized documents to smaller-sized documents in an image production device, the instructions comprising:
receiving a request to scan a larger-sized document;
determining if the larger-sized document is to be converted to a smaller-sized-document, wherein if it is determined that the larger-sized document is to be converted to a smaller-sized-document,
scanning the larger-sized document to obtain image data from each larger-sized document page;
combining the image data from each larger-sized document page into one continuous document;
measuring a predetermined amount of image data from the one continuous document;
positioning the predetermined amount of image data onto a smaller-sized document page;
continue positioning the predetermined amount of image data onto a smaller-sized document pages until there is no more image data left from the one continuous document to position onto a smaller-sized document page; and
one of storing the smaller-sized document in a memory and printing the smaller-sized document.

20. The computer-readable medium of claim 19, wherein the smaller-sized document is one of a letter-sized document and an A4-sized document.

21. The computer-readable medium of claim 19, wherein the predetermined amount of image data is determined so that a minimum amount of white space is provided at the edges of the smaller-sized document pages.

22. The computer-readable medium of claim 21, wherein the minimum amount of white space is 0.25-1.5 inches at the edges of the smaller-sized document pages.

23. The computer-readable medium of claim 19, wherein the predetermined amount of image data may be 9″-10.5″.

24. The computer-readable medium of claim 19, wherein the larger-sized document is one of legal-sized, B (ledger), A3, Super A3, and Super B.

25. The computer-readable medium of claim 19, wherein the image production device is one of a copier, a printer, a facsimile device, and a multi-function device.

26. The computer-readable medium of claim 19, wherein the size of the image data from the larger-sized document is not changed when it is converted to the smaller-sized document.

27. The computer-readable medium of claim 19, wherein the image data is rotated 90 degrees prior to the predetermined amount of image data being positioned onto a smaller-sized document page.
